(19) United States
(12) Patent Application Publication
(10) Pub. No.: US 2007/0080232 A1
(43) Pub. Date: Apr. 12, 2007

(54) INTEGRATED CIRCUIT AND METHOD FOR OBTAINING TECHNICAL INFORMATION OF THE INTEGRATED CIRCUIT

(76) Inventors: Han-Che Wang, Shenzhen (CN); Kuan-Hong Hsieh, Shenzhen (CN); Shin-Hong Chung, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,336

(22) Filed: Jul. 27, 2006

(30) Foreign Application Priority Data
Oct. 7, 2005 (CN) 200510100205.8

(51) Int. Cl. G06K 19/06

(52) U.S. Cl. 235/492

(57) ABSTRACT

A method for obtaining technical information of IC is disclosed. The method provides an IC, a test board, and a computer. The IC includes a memory. The memory stores technical information. Connect the IC to the test board. Connect the test board to the computer. The computer obtains the technical information from the memory of IC. Using this method, engineers can find the technical information of the IC conveniently and correctly.

### FIELD OF THE INVENTION

The present invention relates to an integrated circuit (IC) and a method for obtaining technical information of the IC.

### DESCRIPTION OF RELATED ART

Whenever working with integrated circuits (ICs), engineers need to know parameters and capabilities of the IC. Although these information are supplied in manuals provided by suppliers, the manual is usually a separate entity from the IC. Engineers may have to spend a significant amount of time locating the manual. The manual may also be lost, thus not locatable. Suppliers may also provide the technical information over a network. Engineers may log into a related website to find corresponding technical information. However, the website usually provides an abundant of information other than the related technical information, resulting in engineer spending a huge amount of time browsing through the website before locating the corresponding technical information. Furthermore, the engineer may not even locate the corresponding technical information or may locate a wrong or irrelevant technical information.

Therefore, what is needed is a method for obtaining technical information of an IC conveniently and correctly.

### SUMMARY OF INVENTION

A method for obtaining technical information of an IC is provided herein. The method provides an IC, a test board, and a computer. The IC includes a memory. The memory stores technical information. Connect the IC to the test board. Connect the test board to the computer. Obtain the technical information from the memory of IC.

Further features and advantages will be provided or will become apparent in the course of the following detailed description.

### BRIEF DESCRIPTION OF DRAWINGS

FIG. 1 is a schematic diagram of a hardware infrastructure for obtaining technical information of an IC; and

FIG. 2 is a flow diagram of a preferred method for obtaining technical information of an IC.

### DETAILED DESCRIPTION

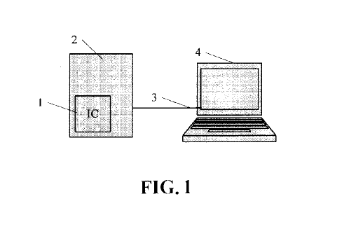

Referring to FIG. 1, a hardware infrastructure for obtaining technical information of an IC is shown. An IC 1 includes a memory. The memory has a predetermined storage area. The predetermined storage area stores technical information therein. The technical information includes specifications, development manuals, etc. To avoid users changing or deleting the technical information, the technical information is designed in a read-only form. In addition, the technical information can be in any suitable formats, such as, for example, PDF, HTML, and so on. The IC 1 is connected to a test board 2 and is electrically connected with the test board 2.

The test board 2 is connected to a computer 4 by a signal link 3. The signal link 3 can be any suitable communication interface, such as, for example, USB port, RS-232 port, and the like. The computer 4 obtains the technical information from the memory of IC 1.

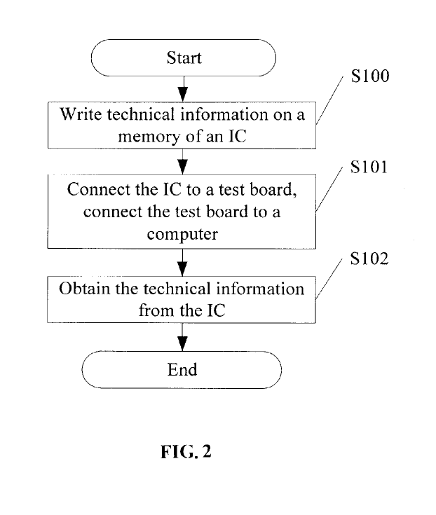

Referring to FIG. 2, a preferred method for obtaining the technical information of the IC 1 is disclosed. In step S100, designers of the IC 1 write the technical information in the memory of the IC 1. The technical information includes specifications, development manuals, etc. The technical information can be stored in PDF, or HTML, or other formats. In step S101, a user of the IC 1 connects the IC 1 to the test board 2 and connects the test board 2 to the computer 4 by the signal link 3, if users desire to know the technical information of the IC1. In step S102, the computer 4 obtains the technical information from the IC 1.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An IC used in a test board, the IC comprising:
a memory storing technical information;
wherein the IC is connected to a computer and transfers the technical information to the computer.

2. The IC of claim 1, wherein the technical information comprises specifications and development manuals.

3. The IC of claim 1, wherein the technical information is in a read-only form.

4. A method for obtaining technical information of an IC, the method comprising the steps of:
providing an IC comprising a memory, wherein the memory stores technical information;
connecting the IC to a test board and connecting the test board to a computer; and
obtaining the technical information from the memory of the IC.

5. The method of claim 4, wherein the technical information comprises specifications and development manuals.

6. The method of claim 4, wherein the technical information is in a read-only form.
